(19) United States
(12) Patent Application Publication
(10) Pub. No.: US 2016/0143066 A1
(43) Pub. Date: May 19, 2016

(54) METHOD AND SYSTEM FOR DISPLAYING WEB APPLICATIONS OF A FIRST COMMUNICATION DEVICE ON A SECOND COMMUNICATION DEVICE BY USING BAN

(71) Applicant: Sony Corporation, Tokyo (JP)

(72) Inventors: Henrik Bengtsson, Lund (SE); Ola Thorn, Limhamn (SE); Aleksandar Rodzevski, Malmo (SE)

(21) Appl. No.: 14/547,242

(22) Filed: Nov. 19, 2014

(51) Int. Cl. H04W 76/02; H04W 68/00

(52) U.S. Cl. CPC H04W 76/02; H04W 68/005

(57) ABSTRACT

A method, system and Body Area Network, BAN, enabled communication devices for displaying content of a first BAN enabled communication device on a second BAN enabled communication device are enclosed wherein the method comprising establishing a BAN link through a human body of a user that is wearing the first BAN enabled device, between the first BAN enabled device and a second BAN enabled device, transmitting the content from the first BAN enabled device to the second BAN enabled device by using the established BAN link, and displaying the transmitted content on a Graphical User Interface, GUI, on the second BAN enabled device, when the user touches the second BAN enabled device.

### TECHNICAL FIELD

The present disclosure relates in general to the field of wireless communication devices, and particularly to communication devices, such as smart phones or tablet, configured to communicate with a consumer electronic device, such as a watch or a wristlet, worn by a user using the user's own body as a communication medium.

### BACKGROUND ART

There is an emerging consumer market for certain devices that are used as companion products to wireless communication devices. Their popularity can be traced, in part, to the variety of features they provide to a user. For example, one such device is a wearable device, such as a ring worn on the user's finger, a necklace, glasses, or a “wristlet” (e.g. a watch or wristband) that is worn around a user's wrist. Typically, such wearable devices may provide different features, such as a logging function that monitors the user's motion and resting activities, and then sends a report on the detected motion and activities to the user's smartphone for storage in memory. Another feature allows the wearable devices to be used as a personal token to automatically gain access to a smartphone that has been locked.

Conventional wireless communication devices are generally connected by being wired to each other or is connected by utilizing different kinds of short range wireless solutions, also referred to as Personal Area Network, PAN using radio-frequency (RF) techniques such as Bluetooth©, infrared Data association (IrDA), ZigBee©, Ultra WideBand (UWB), etc. However, the RF-technique have some drawbacks, e.g. there might be a limited operating time due to relatively high power consumption of the RF transceiver, the risk of interference with other RF systems operating in the same frequency band, and the user is exposed to potentially harmful RF radiation. Moreover, the user needs to manually pair the internet enabled devices, e.g. a wristlet with a mobile phone, in order to establish a RF connection between them.

Sharing files, images or any other information on the internet is ultra-simple today. Sharing offers low control, and does not allow the spontaneous simple sharing that we are used to with physical things. It is today possible to give a stranger on a bus a peek into our pictures from e.g. a fishing trip with physical photos or on a display on a smartphone, tablet or the like. However if we like to show the pictures on the wireless communication device of the stranger e.g. a tablet, we need to log on to our account were we keep our pictures. The disadvantage is that our login information will be stored at the stranger's device, thus it is a security problem.

There is a need for a simple, easier and more intuitive and secure ways of displaying our web-stored content, such as files, images or other information on another person's device by means of easy and convenient methods.

### SUMMARY OF THE INVENTION

An object of the present disclosure is to provide a solution which seeks to mitigate, alleviate, or eliminate one or more of the above and below identified deficiencies in the art and disadvantages singly or in any combination.

An aspect of the present invention relates to a method for displaying content of a first BAN enabled communication device on a second BAN enabled communication device. The method comprising establishing a Body Area Network (BAN) link through a human body of a user that is wearing the first communication device, between said first communication device and said second communication device, when the user touches said second communication device. The method comprising transmitting said content from said first communication device to said second communication device by using said established BAN link, when the user touches said second communication device and displaying said transmitted content on a Graphical User Interface, GUI, represented by a pop-up window, on said second communication device.

An aspect of the present invention relates to a system for displaying content of a first BAN enabled communication device on a second BAN enabled communication device. The first BAN enabled communication device comprising a control application comprising said content; and a processor. The processor of the first BAN enabled device is configured to establish a Body Area Network (BAN) link through a human body of a user wearing the first communication device between the first communication device and the second communication device, when the user touches said second communication device and to transmit said content via said BAN link to said second communication device when said user touches second communication device. The second BAN enabled communication device comprising a Body Area Network (BAN) transceiver circuit configured to a display screen and a processor. The processor of the second BAN enabled device is configured to provide communication with said first communication device via said established BAN link through a human body of said user wearing said first communication device when said user touches said second communication device, to receive said content from said first communication device, via said BAN link, when said user touches said second communication device and opening a Graphical User Interface, GUI, represented by a pop-up window, on said display screen of said second communication device for displaying said received content on said GUI.

The features of the above-mentioned embodiments can be combined in any combinations.

### BRIEF DESCRIPTION OF THE DRAWINGS

Further objects, features and advantages of the present invention will appear from the following detailed description of the invention, wherein embodiments of the invention will be described in more detail with reference to the accompanying drawings, in which:

FIG. 1 shows a system comprising a first and a second communication device according to the disclosure;

FIG. 2 illustrates a user wearing a communication device in one scenario of how the present invention can be implemented;

FIG. 3 shows a wearable BAN enabled communication device according to the disclosure;

FIG. 4 illustrates a user wearing a communication device in one scenario of how the present invention can be implemented;

FIG. 5A-B illustrates a user wearing a communication device in one scenario of how the present invention can be implemented;

FIG. 6 shows a flow chart of the method according to the disclosure;

FIG. 7 shows a BAN enabled communication device according to the disclosure;

FIG. 8 shows an exemplary embodiment of a GUI displaying content according to the disclosure;

FIG. 9 shows exemplary embodiments of BAN enabled communication devices according to the disclosure.

### DETAILED DESCRIPTION

Aspects of the present invention will be described more fully hereinafter with reference to the accompanying drawings. The devices and methods disclosed herein can, however, be realized in many different forms and should not be construed as limited to aspects set forth herein. Like reference signs refer to like elements throughout the text.

As used herein, the term “mobile device” includes mobile communication device and mobile radio communication equipment. Portable communication devices and mobile communication devices may be used synonymously. The term “mobile device” may be referred to below as a mobile phone (or as a mobile telephone, portable phone or portable telephone), a portable device, a portable radio terminal or a portable terminal, which includes all electronic equipment, but not limited to, capable of being used for voice and/or data communication.

As will be appreciated, the invention may be used with mobile phones, other phones, smartphones, personal digital assistants (PDAs), computers, tablets, other electronic communication devices, etc., for brevity, the invention will be described by way of examples with respect to mobile phones, but it will be appreciated that the invention may be used with other electronic communication devices.

A Body Area Network, BAN, also referred to as a Body Coupled Communication, BCC, wireless body area network, WBAN or body sensor network, BSN, is a wireless network of communication devices. BAN enabled devices may be embedded inside the body, implants, may be surface-mounted on the body in a fixed position or may be accompanied devices which humans can touch or carry in different positions, in clothes pockets, by hand or in various bags.

Body Area Network, BAN, standards such as IEEE's 802.15.6 or Sony's CCCC is enabling the possibilities for commercialized BAN devices. The first BAN devices have its background in the medical area, as BAN is a communication standard optimized for low power devices and operation on, in or around the human body. BAN makes it possible to communicate with 2 m or less between the devices over the body in the frequency band 13-40 MHz

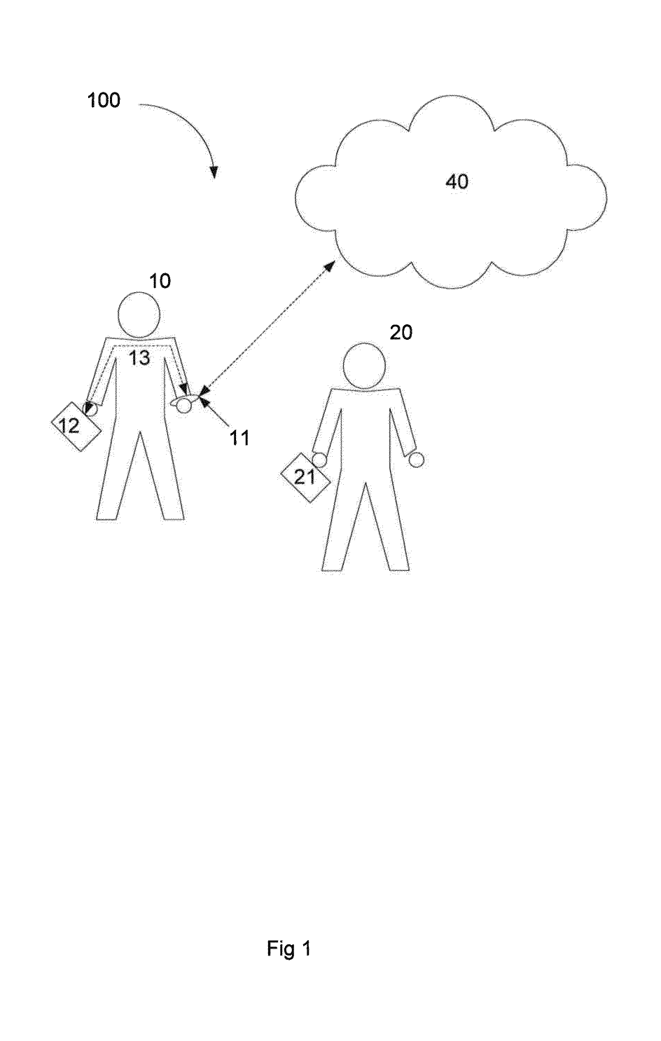

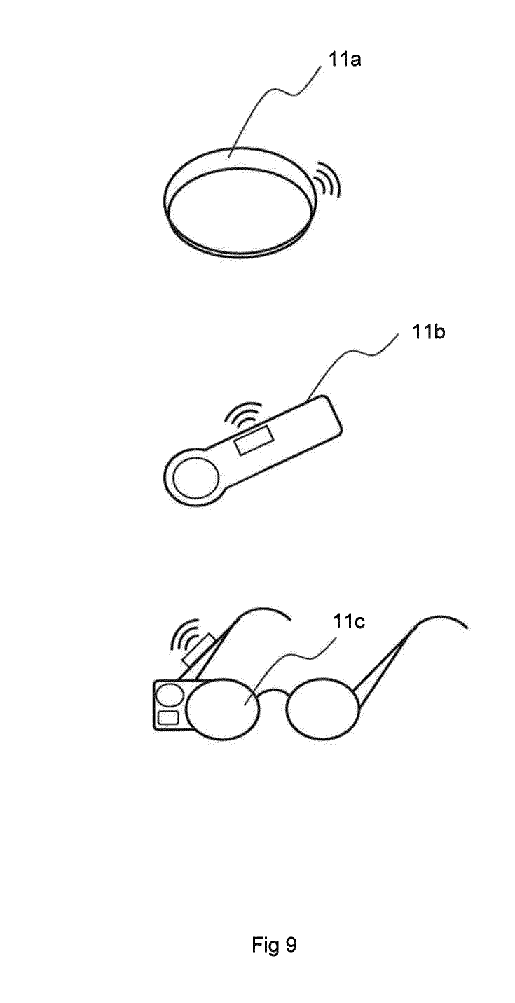

Referring in detail to the drawings, and initially to FIG. 1, a wearable BAN enabled communication device, e.g. a wristlet, in accordance with an embodiment of the present invention is illustrated generally at 11. A wearable BAN enabled communication device 11 in this application refers to a wireless communication device configured to be worn by a person. Examples of such wearable BAN enabled devices are shown in FIG. 9, as wearable BAN enabled accessories i.e. a wristlet 11a, an in-ear hearing device 11b, and googles 11c. The wearable BAN enabled communication device 11, 11a, 11b, 11c will be referred to below as a wearable device 11.

A BAN enabled communication device in accordance with an embodiment of the present invention is illustrated generally at 20. A BAN enabled communication device 20 in this application refers to any BAN enabled communication device to be touched by a user, e.g. a media streaming device, an audio streaming device, a media service device, a tablet, a computer, a PC, a video conference device, a virtual reality device, a head-mounted display, a visor, a gaming console, a touch-enabled surface such as a table etc.

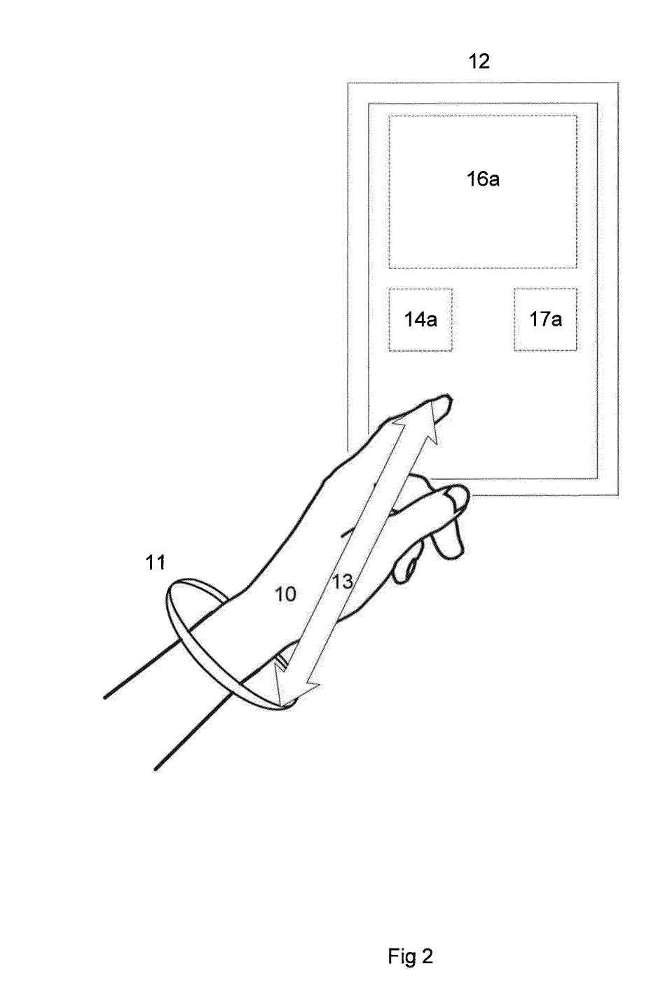

In one embodiment a first user 10 is equipped with at least two BAN enabled communication devices 11, 12, as shown in FIG. 1, a first BAN enabled communication devices 11, such as a wristlet, and a second BAN enabled communication device 12, such as a mobile phone. A BAN connection, a BAN link 13, as shown in FIG. 2, is established between the wristlet 11 and the mobile phone 12, when the user touches the mobile phone 12. The mobile phone transmits web application contents, web app content, to the wristlet 11 over the BAN link 13. Web app content comprises at least one graphical element such as a bitmap representing a web application icon. Each graphical element is accompanied by a link, e.g. a hyperlink, such as a Uniform Resource Locator, URL, or a file shortcut to a user web account, such as Play Memories account, Dropbox account, Google Drive account, Picasa account, You Tube account, Twitter account etc. Credential data or authorization data, such as a user ID, username, login, password, etc., used for getting access to the associated accounts are also transmitted from the mobile phone 12 to the wristlet 11.

In one embodiment, together with the provided credential data the web app content may also be retrieved from a remote storage, such as cloud storage 40.

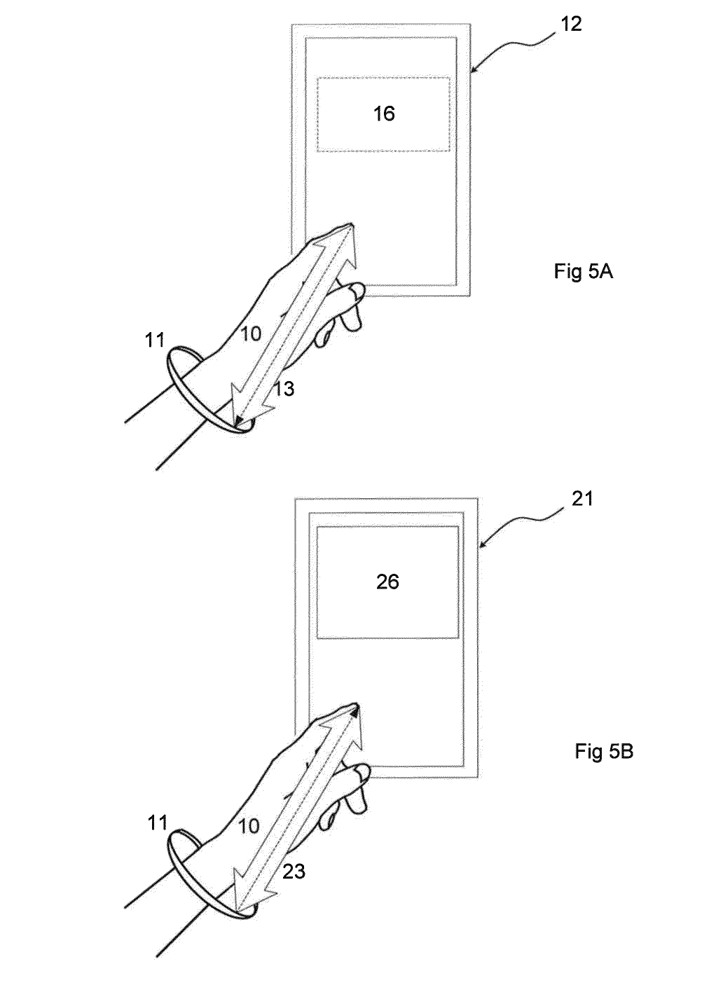

In one embodiment, the web app content is stored in a control application 16a, 16b, as shown in FIGS. 2 and 5A, e.g. a web app container or a map, provided on the communication device 12 of the user, e.g. a mobile phone. A wearable device 11 of the user 10, e.g. a wristlet, is paired with the mobile phone 12, by an establishing BAN link 13, as described above. In one aspect, the content of the control application 16a, 16b is automatically transmitted to the wristlet, from the mobile phone, when the BAN-link is established. In one aspect, the user is asked if he/she would like to transmit the content to the wristlet, before transmitting the content to the wristlet. In one aspect, the stored information on the wristlet can be cleared as soon as the wristlet is removed from the user. In one aspect, there is a BAN service provided on the mobile phone 12 that is configured to continuously detecting and loading all the content that is stored in the control application onto the wristlet 11 paired with the mobile phone 12. In one aspect the user is able to select which graphical element accompanied with a link and/or credential data in the content that should be loaded onto the wristlet.

In one embodiment, shown in FIG. 2, the transmission of web app content of a first communication device 11, 12, e.g. a wristlet or a mobile phone, may be performed according to a stored, predefined user configuration by touching at least one other BAN enabled communication device 21, e.g. a tablet, by the owner or user 10 of the first communication device 11, 12. A RF signal is detected, indicating the presence of the BAN enabled tablet 21, thus confirming that BAN is available. Since the first communication device 11, 12 is BAN enabled it will connect to the tablet 21 directly by using BAN. The user may be asked by the first communication device 11, 12 through a user interface of the first communication device 11, 12 or by interacting with the first communication device 11, 12 in some other way, such as pressing a button, touching a touchpad etc. to confirm that connection with the tablet should be established.

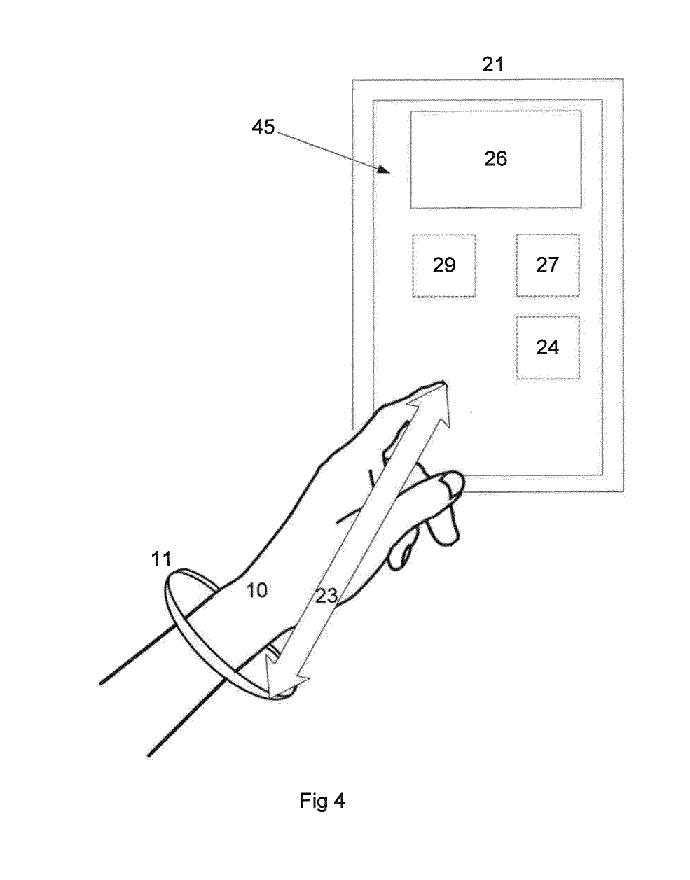

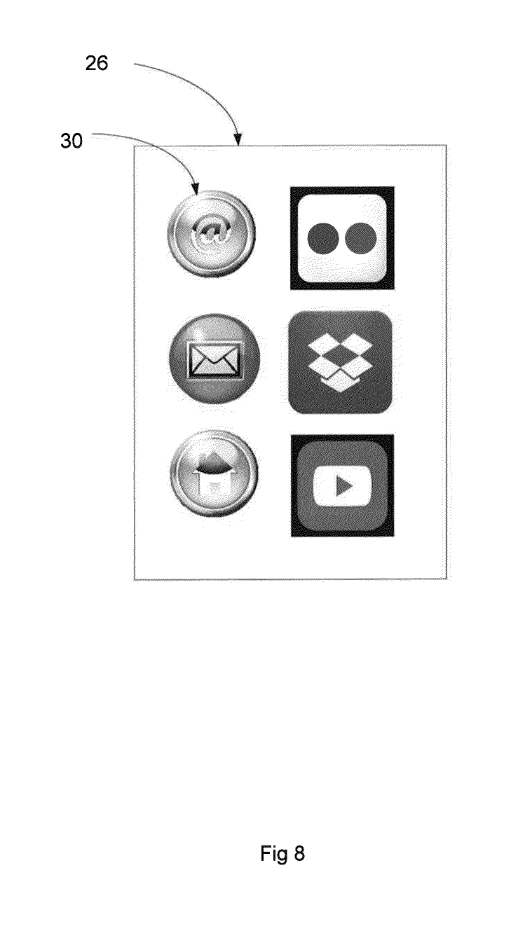

In one embodiment, as illustrated in FIGS. 4, 5B and 8, a first user 10, equipped with a BAN enabled wristlet comprising web app content with associated credential data, would like to show his pictures or favourite film clips on a BAN enabled communication device, e.g. tablet of a second user 20. The first user grabs the tablet 21 and the wristlet 11 connects with the tablet 21 by using an automatically established BAN link 23. A pop-up window 26 will open on the display 45 of the tablet and the web app content in form of bitmap icons 30 linked to the web application account comprising the pictures or film clips, e.g. drop box account or YouTube account, is automatically transmitted to the tablet via the BAN link 23 and displayed on the pop-up window 26. The first user may now be able to share and display his pictures or favourite film clips on the tablet 21 of the second user 20 by clicking on the displayed icons 30. When the first user leaves the tablet back to the second user, the BAN link 23 is removed and the pop-up window 26 will close down. If any data, such as shown links, credential data, pictures or film clips, has been saved on the tablet, they may also be removed from the tablet when the BAN link is removed and the pop-up window close down. In one aspect, there is a BAN service provided on the tablet 21 and when the tablet receives the web app content the BAN service is configured to open a web-view in the form of a pop-up window and the web app content is displayed on the pop-up window in the form of bitmap icons. The BAN service is configured to read the links and accompanied username and password for the chosen icon from the wristlet. The BAN service opens the web interface of the chosen account and inserts the link together with the username/password. In one aspect, if the first and/or second user does not want to show any content they just close the pop-up window and the tablet continues to work as before. When the second user is finished showing the pictures he hands the tablet back to the first user. The BAN link is removed, the user is logged out of the accounts and the pop-up window close down.

By using web application content the users doesn't have to consider installing applications on other devices, the only requirement will be to have a web interface and access to internet.

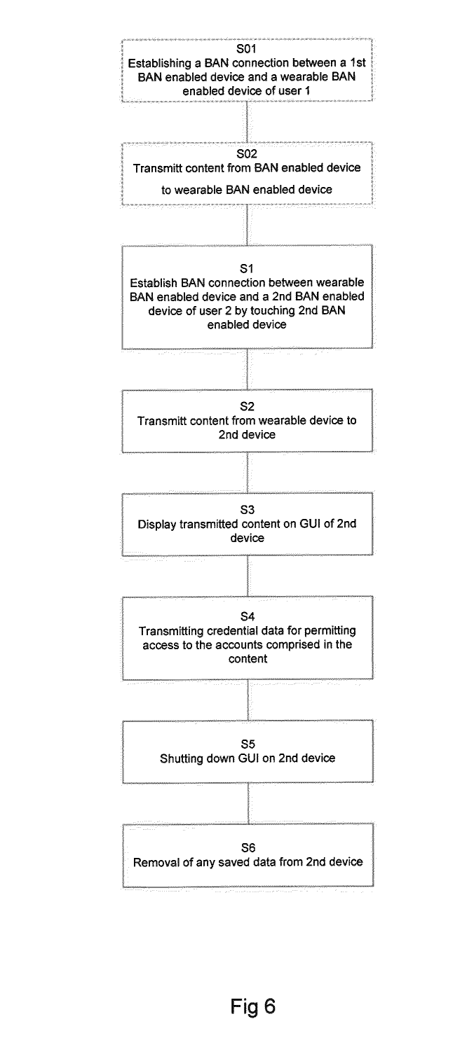

The method will now be described starting from FIG. 6 disclosing method steps, performed in a system including a wearable first BAN enabled communication device 11 of a first user 10 and a second BAN enabled communication device 21 of a second user. When the described steps are not dependent on each other, these steps may be implemented in any combination.

The wearable first BAN enabled communication device 11 is connected to another BAN enabled communication device 12 of the first user through BAN, BLE, Wi-Fi, as shown in FIG. 5A, or may be connected to a cloud service 40 through BLE, Wi-Fi, for enabling transmission of a web application content according to a stored, predefined user configuration associated with an identification data, user ID, of the wearable first BAN enabled communication device 11.

In a first initial step a Body Area Network (BAN) link 13 is established S01 through a human body of the user 10 that is wearing the wearable first BAN enabled communication device 11, e.g. a wristlet, between the wristlet and a second communication device 12 of the user 10, e.g. a mobile phone, when the user touches the mobile phone 12.

In a second initial step the content is transmitted S02 from the mobile phone 12 to the wristlet 11 by using the established BAN link 13, when the user touches the mobile phone.

In the first step a Body Area Network (BAN) link 23 is established S1 through a human body of a user 10 that is wearing a first communication device 11, e.g. a wristlet, between the first communication device and a second communication device 21, e.g. a tablet, when the user touches the tablet 21.

In the second step content is transmitted S2 from the wristlet 11 to the tablet 21 by using the established BAN link 23, when the user touches the tablet 21.

In the third step the transmitted content is displayed or presented S3 on a Graphical User Interface 26, GUI, represented by a pop-up window, on the tablet 21.

The content comprises at least one graphical element, such as a bitmap icon or any other visual indicator representing a link, such as a hyperlink or file shortcut, to a web account of, e.g. YouTube account, of the user.

In a fourth step credential data for permitting access to the web account is transmitted S4 from the wristlet 11 to the tablet 21 by using the established BAN link 23, when the user activates the content. In one aspect the user touches any of the graphical elements displayed on the GUI 26.

In a fifth step the GUI 26 is shut S5 down when detecting that the user stop touching the tablet or when detecting removal of the wristlet.

In a sixth step any saved data, such as any saved links, pictures, film clips, username or passwords, is removed S6 or deleted from the tablet in response to detecting when the user stop touching the tablet or when detecting removal of the wristlet 11.

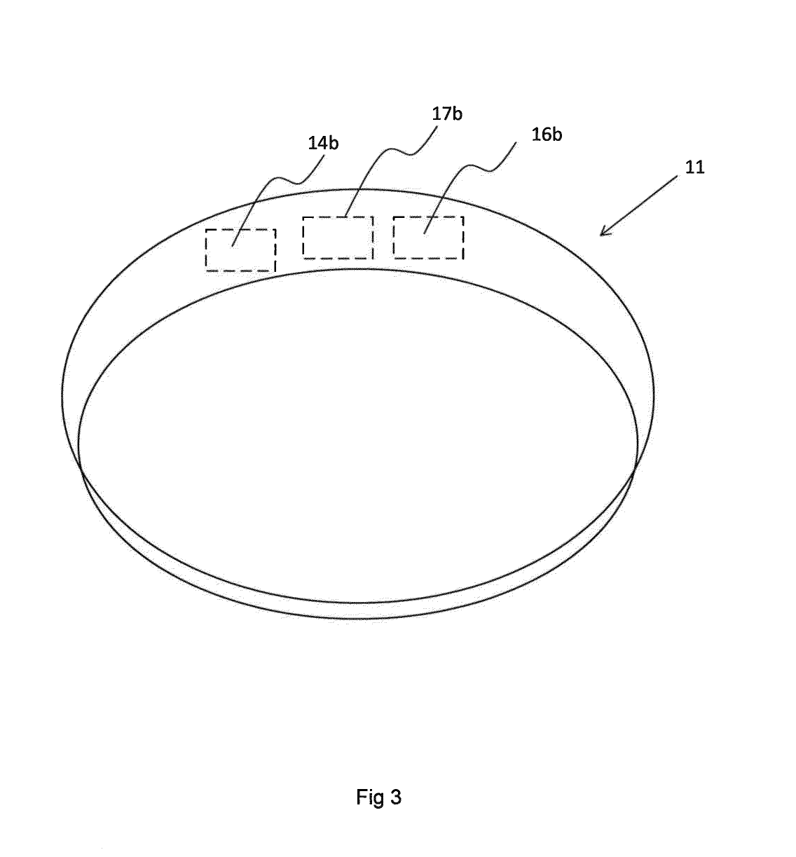

FIGS. 1 to 5 and 7 shows a BAN enabled communication device 12, 21, which will now be described in further detail, configured for displaying content of a wearable communication device 11 on the BAN enabled communication device 12, 21. The BAN enabled communication device may be any communication device and a tablet is shown only as an exemplary object. The BAN enabled communication device is equipped with BAN electronic module 14a, 14b, 24. The electronic module may be designed as touchable area on the BAN enabled communication device or may be designed as a tag or pod to be permanently attached to the communication device or to be removable from the communication device. The BAN electronic module comprises a detector unit 29 configured for detecting a RF signal which indicates the presence of another BAN enabled communication device.

In one embodiment the detector unit comprises a capacitive touch system. The capacitive sensor system has low power consumption, which is less than 30 microampere, when the BAN enabled communication device is touched. The sensitive range may be set to the range of 20-30 mm. The capacitive sensor system is always active. As soon as the user, who is wearing a BAN enabled communication device, touches or is close to another BAN enabled communication device the detector unit starts to sense the presence of the other BAN enabled communication device.

The BAN electronic module 14a, 14b, 24 further comprises a radio communication interface configured to communicate with another BAN enabled communication device by using BAN.

The BAN enabled communication device 12, 21 further comprises a processor 17a, 17b, 27. The processor is configured to execute the method according to the disclosure. The processor is typically a processing circuitry constituted by any suitable Central Processing Unit, CPU, microcontroller, Digital Signal Processor, DPS, etc. configured for executing computer code, such as a computer program implementing the proposed method. One example is that the computer code is an application, which may be downloaded from an external server. However, the method may as well be hardware implemented or a combination of hardware and software. The computer program may be stored in a memory, MEM, not shown. The memory can be any combination of a Random access Memory, RAM, and a Read only Memory, ROM. The memory may also comprise persistent storage, which for example, can be any single one or combination of magnetic memory, optical memory, or solid state memory or even remotely mounted memory.

The processor is configured to broadcast a signal, indicating ability to connect and/or transmit web app content, when the detector unit 29 detects the presence of a BAN enabled communication device.

In one embodiment, a first BAN enabled communication device 21, e.g. a tablet, comprises a display screen 45 and a processor 27 configured to provide communication between the tablet and a second BAN enabled communication device 11 e.g. a wristlet, via a BAN link 23 through a human body of a user 10 wearing the wristlet, when the user 10 touches the tablet 21.

In one embodiment, the processor 27 is configured to receive the content from the wristlet 11, via the BAN link 23, when the user touches the tablet 21. The processor is configured to open a Graphical User Interface 26, GUI, represented by a pop-up window, on a display screen 45 of the tablet 21 for displaying the received content.

In one aspect the displayed content comprises at least one graphical element representing a link to an account of the user and wherein the processor 27 is configured to receive credential data, such as username and password, for permitting access to the accounts, from the wristlet 11, when the user activates the graphical element, e.g. touching any of the at least one displayed bitmap icons on the pop-up window. In one embodiment, the tablet comprises a sensor 29 configured for detecting when the user stop touching the tablet 21. The processor 27 is configured to shut down said GUI in response to detecting when the user stops touching the tablet 21.

In one embodiment, the tablet comprises a sensor 29 configured for detecting when the user stop touching the tablet 21. The processor 27 is configured to shut down said GUI in response to detecting when the user stops touching the tablet 21.

In one embodiment the processor 27 is configured to remove any saved data on the tablet in response to detecting the when the user stop touching the tablet 21.

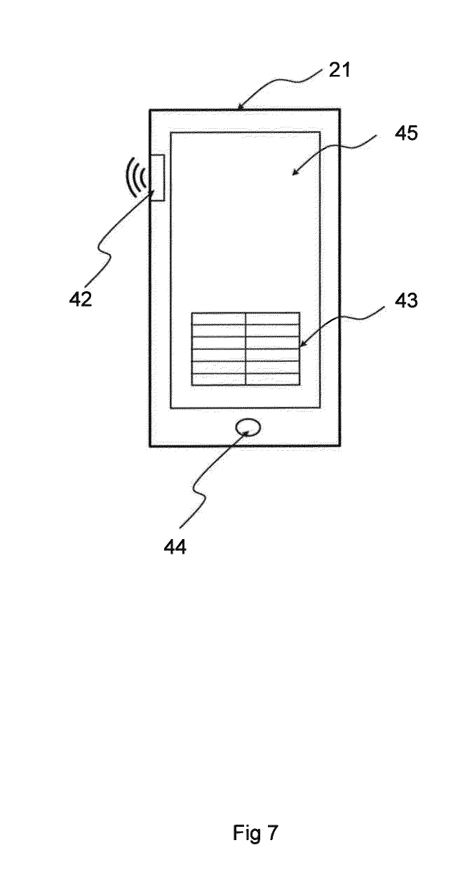

The mobile device 12, 21, as shown in FIG. 7, further comprises a wireless communication interface (i/f) 42 arranged for wireless communication with cellular communication systems and/or other wireless communication systems. The wireless communication interface may be adapted to communicate over one or several radio access technologies. If several technologies are supported, the access point typically comprises several communication interfaces, e.g. one WLAN communication interface and one cellular communication interface. The communication interface is e.g. adapted to download a computer program for executing the proposed methods or access a data base comprising device specific information.

The mobile phone further comprises an input unit 43, such as a keyboard and a microphone 44.

FIGS. 1 to 5B and 9 shows a wearable BAN enabled communication device 11, 11a, 11b, 11c, which now will be described in further detail. A wearable BAN enabled communication device 11 may be any BAN enabled accessory worn by the user 10, such as a headset, watch, bracelet or a ring, and a wristlet which is shown only as an exemplary warble device. A BAN connection, BAN link 13, is established between the wristlet 11 and a communication device 12, e.g. a mobile phone, of the user.

In one embodiment a first BAN enabled communication device 11, 12, e.g. a wristlet, is configured for displaying content of the wristlet 11 on a second BAN enabled communication device 21, e.g. a tablet. The wristlet comprises a control application 16b, such as a web application or a map, comprising the content. The wristlet comprises a processor 17b configured to provide communication between the wristlet 11 and the tablet 21 via a BAN link 23 through the human body of the user wearing the wristlet 11, when the user touches the tablet 21. The processor 17 is configured to transmit the content comprised in the control application 16b via the BAN link 23 to the tablet 21 when the user touches the tablet 21.

The transmitted content comprises at least one graphical element, such as an icon represented by a bitmap or another visual indicator representing a link, such as a hyperlink, which is a reference in an electronic document that lets a user display or activate another document or program, e.g. an Uniform Resource Locator, URL, or a file shortcut to an account of the user, such as a YouTube account, a Twitter account, a Flickr account etc.

In one embodiment the processor is configured to transmit authentication data or credential data such as username and password to the tablet for permitting access to the account when said user activates the graphical element. The graphical element is activated when the user touches or selects any of the displayed graphical elements.

In one embodiment the processor is configured to remove any saved data on the wristlet in response to detecting a removal of the wristlet from the user.

FIG. 1 show a system 100 configured for displaying content of a first communication device 11, 12 on a second communication device 21. The system comprises a first communication device 11, 12 and a second communication device 21.

In one embodiment, the first communication device 11 is a wearable BAN enabled communication device 11, 11a, 11b, 11c, as described in further detail above.

In one embodiment, the first communication device 11 is a BAN enabled communication device 12, as described in further detail above.

In one embodiment, the second communication device 21 is a BAN enabled communication device, as described in further detail above.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The foregoing has described the principles, preferred embodiments and modes of operation of the present invention. However, the invention should be regarded as illustrative rather than restrictive, and not as being limited to the particular embodiments discussed above. The different features of the various embodiments of the invention can be combined in other combinations than those explicitly described. It should therefore be appreciated that variations may be made in those embodiments by those skilled in the art without departing from the scope of the present invention as defined by the following claims.

1. A method for displaying content of a first BAN enabled communication device on a second BAN enabled communication device, wherein said method comprising:
establishing a Body Area Network (BAN) link through a human body of a user that is wearing the first communication device, between said first communication device and said second communication device, when the user touches said second communication device;
transmitting said content from said first communication device to said second communication device by using said established BAN link, when the user touches said second communication device; and
displaying said transmitted content on a Graphical User Interface, GUI, represented by a pop-up window, on said second communication device.

2. The method for displaying content according to claim 1, wherein said transmitted content comprises at least one graphical element representing a link to a web account of said user.

3. The method for displaying content according to claim 1, wherein said method comprising:
transmitting credential data for permitting access to said accounts, from said first communication device to said second communication device by using said established BAN link, when the user activates said content.

4. The method for displaying content according to claim 1, wherein said method comprising:
shutting down said GUI in response to detecting when said user stop touching said second communication device; and
removing any saved data on said second communication device.

5. The method for displaying content according to claim 1, wherein said method comprising:
shutting down said GUI in response to detecting the removal of said first communication device;
removing any saved data on said first communication in response to detecting the removal of said first communication device.

6. A system for displaying content of a first BAN enabled communication device on a second BAN enabled communication device, wherein the system comprising:
said first BAN enabled communication device comprising:
a control application comprising said content; and
a processor configured to:
establish a Body Area Network (BAN) link through a human body of a user wearing the first communication device, between said first communication device and said second communication device, when the user touches said second communication device; and
transmit said content via said BAN link to said second communication device when said user touches second communication device,
said second BAN enabled communication device comprising:
a Body Area Network (BAN) transceiver circuit configured to
a display screen; and
a processor configured to:
provide communication with said first communication device via said established BAN link through a human body of said user wearing said first communication device, when said user touches said second communication device;
receive said content from said first communication device, via said BAN link, when said user touches said second communication device; and
opening a Graphical User Interface, GUI, represented by a pop-up window, on said display screen of said second communication device for displaying said received content on said GUI.

7. The system according to claim 6, wherein said content comprises at least one graphical element representing a link to account of said user.

8. The system according to claim 6, wherein said content comprises at least one graphical element representing a link to account of said user and wherein said processor of said first communication device is configured to transmit credential data for permitting access to said account, from said first communication device to said second communication device by using said established BAN link, when said user activates said graphical element.

9. The system according to claim 6, wherein said content comprises at least one graphical element representing a link to account of said user and wherein said processor of said second communication device is configured to receive credential data for permitting access to said account, from said first wireless electronic device, when said user activates said graphical element.

10. The system according to claim 6, wherein said second communication device comprising a sensor configured for detecting when said user stop touching said second communication device, and said processor of said second communication device is configured to shut down said GUI in response to detecting when the said user stop touching said second communication device.

11. The system according to claim 6, wherein said processor of said second communication device is configured to remove any saved data on said second communication device in response to detecting when said user stop touching said second communication device.

12. The system according to claim 6, wherein said processor of said first communication device is configured to remove any saved data on said first communication device in response to detecting a removal of said first communication device from said user.

13. A first BAN enabled communication device for displaying content of said first communication device on a second communication device, wherein said first communication device comprising:
a control application comprising said content;
a processor configured to:
provide communication between said first communication device and said second communication device via a BAN link through a human body of a user wearing said first communication device, when said user touches said second communication device; and
transmit said content comprised in said control application via said BAN link to said second communication device when said user touches said second communication device.

14. The first communication device, according to claim 13, wherein said content comprises at least one graphical element representing a link to an account of said user.

15. The first communication device, according to claim 13, wherein said content comprises at least one graphical element representing a link to an account of said user and wherein said processor is configured to transmit credential data to said second communication device for permitting access to said account when said user activates said graphical element.

16. The first communication device, according to claim 13, wherein said processor of is configured to remove any saved data on said first communication device in response to detecting a removal of said first communication device from said user.

17. A first BAN enabled communication device for displaying content of a second communication device on said first communication device, wherein said first communication device comprises:
a display screen; and
a processor configured to:
provide communication between said first communication device and said second communication device via a BAN link through a human body of a user wearing said second communication device, when said user touches said first communication device;
receive said content from said second communication device, via said BAN link, when said user touches said first communication device; and
open a Graphical User Interface, GUI, represented by a pop-up window, on said display screen of said first communication device for displaying said received content on said GUI.

18. The first communication device, according to claim 17, wherein said displayed content comprises at least one graphical element representing a link to an account of said user.

19. The first communication device according to claim 17, wherein said displayed content comprises at least one graphical element representing a link to an account of said user and wherein said processor is configured to receive credential data for permitting access to said account, from said second communication device, when said user activates said graphical element.

20. The first communication device, according to claim 17, comprising a sensor configured for detecting when said user stop touching said first communication device, wherein said processor is configured to shut down said GUI in response to detecting when said user stop touching said first communication device.

21. The first communication device, according to claim 17, comprising a sensor configured for detecting when said user stop touching said communication device, wherein said processor is configured to remove any saved data on said first communication device in response to detecting when said user stop touching said first communication device.
